(19) United States
(12) Patent Application Publication
(10) Pub. No.: US 2012/0312752 A1
(43) Pub. Date: Dec. 13, 2012

(54) METHOD AND APPARATUS OF REMOVING PHOSPHORUS FROM SEWAGE WASTEWATER BY ELECTROCOAGULATION USING ELECTRODES HAVING POROUS MEMBRANE THEREBETWEEN

(76) Inventors: Kwang Soo Kim, Gyeonggi-do (KR); Jung O. Park, Gwangju (KR); Tae Hwan Jun, Gyeonggi-do (KR)

(21) Appl. No.: 13/490,834

(22) Filed: Jun. 7, 2012

(30) Foreign Application Priority Data
Jun. 8, 2011 (KR) 10-2011-0055213

(51) Int. Cl. C02F 9/06; C02F 1/52; C02F 1/463; C02F 101/10

(52) U.S. Cl. 210/719; 205/746; 204/252; 204/261; 210/207

(57) ABSTRACT

Disclosed is a method of removing phosphorus from sewage wastewater by electrocoagulation, comprising: providing an electrode assembly comprising an anode and a cathode with a porous membrane interposed therebetween; placing the electrode assembly in an electrocoagulation tank; passing sewage wastewater through the electrocoagulation tank to treat the sewage wastewater by electrocoagulation; and introducing the treated water into a mixing tank to further treat the water. Also disclosed is an apparatus of removing phosphorus from sewage wastewater by electrocoagulation, comprising: an electrode assembly comprising an anode and a cathode with a porous membrane interposed therebetween; at least one electrocoagulation tank in which the electrode assembly is placed and sewage wastewater is treated by electrocoagulation; and a mixing tank, which receives the treated water and in which treated water passed through the anode and treated water passed through the anode are mixed and further treated to remove untreated phosphorus.

### CROSS-REFERENCES TO RELATED APPLICATIONS

The present application claims priority of Korean Patent Application Nos. 10-2011-0055213, filed on Jun. 8, 2011, which are incorporated herein by reference in their entireties.

### BACKGROUND OF THE INVENTION

1. Field of the Invention

The present invention relates to a method and apparatus of removing phosphorus from sewage, and more particularly to a method and apparatus of removing phosphorus by electrocoagulation using electrodes having a porous membrane therebetween, in which phosphorus is removed from sewage by allowing metal ions, dissolved from iron or aluminum electrodes by electrolysis, to react with phosphate ions (PO₄⁻³) contained in the sewage water. In the present invention, a porous membrane is placed between an anode and a cathode, and the removal of phosphorus is performed in the anode region, thereby maximizing the efficiency of removal of phosphorus and minimizing the generation of sludge caused by electrocoagulation.

In addition, a metal ion-reducing agent is used in order to remove color from treated water and enhance the settlement of sludge.

2. Description of Related Art

Generally, sewage mainly contains carbon, nitrogen, phosphorus, and the like. A typical method for removing such components from sewage is a biological treatment method which uses microbial metabolic activity. Herein, carbon, nitrogen and phosphorus are treated at a ratio of 100:5-10:1.

However, because the contents of nitrogen and phosphorus in sewage are larger than the amounts that are metabolized by microorganisms in proportion to the carbon component, untreated nitrogen and phosphorus are generally discharged into rivers. Thus, such untreated nitrogen and phosphorus cause eutrophication in water reservoirs such as dams and lakes.

Particularly, among the nitrogen and phosphorus components, the nitrogen component plays the most crucial role in algal growth. For this reason, the concentration of phosphorus in effluent water is required to be reduced to a specific concentration or below, for example, 0.2 mg/L, by performing chemical treatment after biological treatment.

In a typical chemical method for removing phosphorus, when a solution of an aluminum salt (Al₂(SO₄)₃)) or an iron salt (FeSO₄ or FeCl₃) is introduced into sewage, an insoluble precipitate (hereinafter referred to as “metal phosphate”) such as aluminum phosphate (AlPO₄) or iron phosphate (FePO₄), which is sludge caused by chemical treatment, is produced as shown in the following equations (1) and (2), thereby removing phosphorus:

Al₂(SO₄)₃+2PO₄³⁻→2AlPO₄↓+3SO₄²⁻ (1)

FeCl₃+PO₄³⁻→FePO₄↓+3Cl⁻ (2)

In this chemical process for removing phosphorus, there is problem in that the iron or aluminum salt also reacts with an alkaline substance (HCO₃⁻) in water in addition to the phosphorus component so as to form an iron oxide precipitate (Fe(OH)₂) as shown in the following equation (3) or an aluminum oxide (Al(OH)₃) precipitate (hereinafter referred to as “metal hydroxide”) as shown in the following equation (4), and thus the amount of precipitates increases, thus increasing the final disposal cost:

Al₂(SO₄)₃+6HCO₃⁻→2Al(OH)₃↓+6CO₂+3SO₄⁻³ (3)

FeCl₃+3HCO₃⁻→Fe(OH)₃↓+3CO₂+3Cl⁻ (4)

The above-described chemical treatment method has a problem in that complex systems for the storage, dissolution and automatic injection of chemicals are required.

Meanwhile, alternative treatment methods to the chemical treatment method having the above problems include an electrochemical method of removing phosphorus using an iron or aluminum plate as an electrode.

In this electrochemical method, when DC electric power is applied to the electrodes made of the iron or aluminum plate, the iron (Fe⁺² or Fe⁺³) or aluminum (Al⁺³) component is dissolved from the anode by electrolysis, and thus the removal of phosphorus is performed in the same manner as the above chemical treatment method shown in equation (1) or (2). In the cathode region, water is electrolyzed as shown in the following equation (5), thereby generating a hydroxyl radical (OH⁻) hydrogen gas. This treatment method is a method of treating phosphorus by electrocoagulation.

2H₂O+2e→H₂↑+2OH⁻ (5)

However, in this phosphorus treatment method, the hydroxyl group generated by the electrolysis of water in the cathode region reacts with iron or aluminum to form a precipitate of iron oxide and aluminum oxide, which is sludge generated by electrocoagulation. For this reason, the amount of the final precipitate is very large, like the conventional chemical treatment method, and thus there are problems in terms of the treatment process and the treatment cost.

Moreover, this treatment method has a problem in that the hydrogen gas produced by the electrolysis of water forms a scum in the upper portion of the reactor without being precipitated, because it forms bubbles which adhere to the insoluble iron phosphate and aluminum phosphate and the iron hydroxide and aluminum hydroxide precipitates to generate buoyancy. In addition, it has a problem in that unreacted iron and aluminum ions color the final treated water (red in the case of iron ions and gray in the case of aluminum ions), thus deteriorating the appearance of the water.

### SUMMARY OF THE INVENTION

Accordingly, the present invention has been made in view of the above-described problems occurring in the prior art, and it is an object of the present invention to provide a method and apparatus of removing phosphorus from sewage wastewater by electrocoagulation using electrodes having a porous membrane therebetween, in which phosphorus can be removed with only iron phosphate or aluminum phosphate, and the production of a sludge of metal hydroxides such as iron hydroxide or aluminum hydroxide can be inhibited, thus reducing the amount of precipitates, and also a scum can be prevented from being generated by hydrogen gas.

Another object of the present invention is to provide a method and apparatus of removing phosphorus from sewage wastewater by electrocoagulation using electrodes having a porous membrane therebetween, in which color can be removed from treated water of sewage wastewater, and the settlement of sludge generated by electrocoagulation can be enhanced.

To achieve the above objects, in accordance with a first aspect of the present invention, there is provided a method of removing phosphorus from sewage wastewater by electrocoagulation, the method comprising: providing an electrocoagulation tank for treating sewage, the electrocoagulation tank including an electrode assembly comprising an anode and a cathode with a porous membrane interposed therebetween; passing the sewage wastewater through the electrocoagulation tank to treat the sewage wastewater by electrocoagulation; and introducing the treated water, passed through the electrocoagulation tank, into a mixing tank.

The method of the present invention preferably further comprises: injecting air from the bottom of a space, which includes the anode, when treating the sewage wastewater by electrocoagulation; and stirring the treated water introduced into the mixing tank.

The method of the present invention preferably further comprises introducing a metal ion-reducing agent into the mixing tank in order to remove color from the treated water and enhance the settlement of sludge caused by electrocoagulation.

In accordance with a second aspect of the present invention, there is provided a method of removing phosphorus from sewage wastewater by electrocoagulation, the method comprising: providing an electrode assembly comprising an anode and a cathode with a porous membrane interposed therebetween; placing the electrode assembly in an electrocoagulation tank for treating sewage wastewater; passing sewage wastewater through the electrocoagulation tank to treat the sewage wastewater by electrocoagulation; and introducing the treated water, passed through the electrocoagulation tank, into a mixing tank to further treat the treated water.

Placing the electrode assembly in the electrocoagulation tank is performed such that a space including the anode is larger than a space including the cathode.

The method according to the second aspect of the present invention preferably further comprises injecting air from the bottom of a space, which includes the anode, into the electrocoagulation tank, in order to uniformly mix metal ions, generated by electrocoagulation, with phosphate ions contained in the sewage wastewater.

The method of the present invention preferably further comprises stirring the treated water introduced into the mixing tank, when further treating the treated water.

The method of the present invention preferably further comprises introducing a metal ion-reducing agent into the mixing tank in order to remove color from the treated water and enhance the settlement of sludge generated by electrocoagulation.

The anode and cathode of the electrode assembly may be made of an iron or aluminum plate, and the metal ion-reducing agent may be sodium borohydride (NaBH₄).

In accordance with a third aspect of the present invention, there is provided an apparatus of removing phosphorus from sewage wastewater by electrocoagulation, the apparatus comprising: an electrode assembly comprising an anode and a cathode with a porous membrane interposed therebetween; at least one electrocoagulation tank in which the electrode assembly is placed and sewage wastewater is treated by electrocoagulation using the electrode assembly; and a mixing tank, which receives the treated water from the electrocoagulation tank and in which the treated water passed through the anode and the treated water passed through the anode are mixed with each other and further treated so as to remove phosphorus which was not treated in the electrocoagulation tank.

The electrode assembly is preferably placed in the electrocoagulation tank such that a space including the anode of the electrode assembly is larger than a space including the cathode.

The apparatus of the present invention may further comprise an air injection device, which serves to inject air into the electrocoagulation tank in order to uniformly mix phosphate ions of the sewage wastewater with metal ions dissolved from the electrodes, the air injection device being placed at the bottom of the space including the anode.

The apparatus of the present invention preferably comprises a device for introducing a metal ion-reducing agent into the mixing tank in order to remove color from the treated water and enhance the settlement of sludge generated by electrocoagulation.

The anode and cathode of the electrode assembly may be made of an iron or aluminum plate, and the porous membrane of the electrode assembly may be made of nonwoven fabric. In addition, the metal ion-reducing agent for removing color and enhancing the settlement of sludge generated by electrocoagulation may be sodium borohydride (NaBH₄).

The distance between the porous membrane and the anode and the distance between the porous membrane and the cathode are such that migration of charges therebetween is possible. In addition, the distance between the cathode and the partition wall of the electrocoagulation tank is preferably shorter than the distance between the cathode and the partition wall of the electrocoagulation tank.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a flow chart showing the inventive method of removing phosphorus from sewage wastewater by electrocoagulation using electrodes having a porous membrane interposed therebetween; and

FIG. 2 schematically shows one preferred embodiment of the inventive apparatus of removing phosphorus from sewage wastewater by electrocoagulation using electrodes having a porous membrane interposed therebetween.

### DESCRIPTION OF SPECIFIC EMBODIMENTS

Additional objects, features and advantages of the present invention will be more clearly understood from the following detailed description and the accompanying drawings.

The inventive apparatus of removing phosphorus from sewage wastewater by electrocoagulation using electrodes having a porous membrane therebetween comprises: at least one electrocoagulation tank; an electrode assembly placed in the electrocoagulation tank and comprising an anode and a cathode with a porous membrane interposed therebetween; and a mixing tank placed at one side of the electrocoagulation tank (downstream side in the direction in which the sewage wastewater is treated).

An air injection device (air stone) is placed at one side of the lower portion of the electrocoagulation tank. Preferably, the air injection device is placed below the anode. The apparatus of the present invention further comprises a device for injecting a metal ion-reducing agent into the mixing tank in order to remove color from treated water resulting from the electrocoagulation tank and to enhance the settlement of sludge generated by electrocoagulation.

In addition, the inventive method of removing phosphorus from sewage wastewater by electrocoagulation using electrodes having a porous membrane therebetween comprises: providing an electrocoagulation tank for treating sewage wastewater, the electrocoagulation tank including an electrode assembly comprising an anode and a cathode with a porous membrane interposed therebetween; passing sewage wastewater through the electrocoagulation tank to treat the sewage wastewater by electrocoagulation; and introducing the treated water, passed through the electrocoagulation tank, into a mixing tank.

The method of the present invention comprises injecting air from the bottom of the electrocoagulation tank when treating the sewage wastewater by electrocoagulation. This air injection is preferably performed from a portion of the bottom of a space including the anode.

In addition, the method of the present invention may further comprise introducing a metal ion-reducing agent into the mixing tank in order to remove color from the treated water and enhance the settlement of sludge generated by electrocoagulation.

Hereinafter, a method and apparatus of removing phosphorus from sewage wastewater by electrocoagulation using electrodes having a porous membrane therebetween according to a preferred embodiment of the present invention will be described with reference to the accompanying drawings.

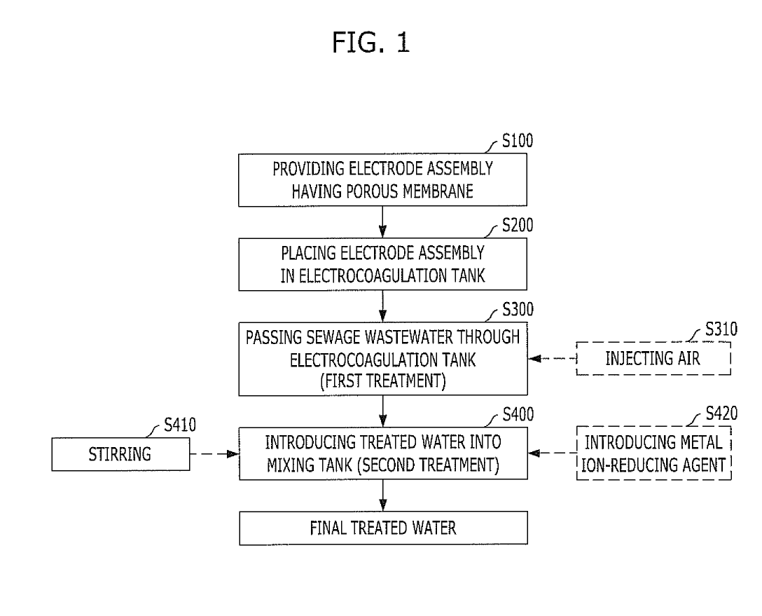

FIG. 1 is a flow chart illustrating a method of removing phosphorus from sewage wastewater by electrocoagulation using electrodes having a porous membrane therebetween according to the present invention.

As shown in FIG. 1, the method of removing phosphorus from sewage wastewater by electrocoagulation using electrodes having a porous membrane therebetween according to the present invention comprises: (S100) providing an electrode assembly comprising an anode and a cathode with a porous membrane interposed therebetween; (S200) placing the electrode assembly in an electrocoagulation tank for treating sewage wastewater; (S300) passing the sewage wastewater through the electrocoagulation tank to treat the sewage wastewater by electrocoagulation; and (S400) introducing the treated water into a mixing tank to further treat the treated water.

As described below in detail, process (S300) of treating the sewage wastewater by electrocoagulation may comprise (S310) injecting air from the bottom of the electrocoagulation tank so as to uniformly mix metal ions and phosphate ions, which are generated by electrocoagulation. Herein, this air injection is preferably performed from a portion of the bottom of the anode.

Moreover, the method of the present invention further comprises (S410) stirring the treated water in the mixing tank in step (S400) of introducing the treated water into the mixing tank.

When metal ions are dissolved from the anode in an amount larger than an appropriate amount, they can cause a problem in terms of the color of the treated water. For this reason, the method of the present invention further comprises (S420) introducing a metal ion-reducing agent into the mixing tank in order to remove color from the treated water and to enhance the settlement of sludge generated by electrocoagulation.

Hereinafter, the process of removing phosphorus from sewage wastewater using the electrocoagulation apparatus having the porous membrane will be described in detail.

Before the process of removing phosphorus according to the present invention is described, the technical background for removing suspended solids by an electrocoagulation reaction as mentioned in the Description of Prior Art will be briefly described.

In an electrocoagulation reaction on electrodes including an anode and a cathode, metal ions are dissolved from the anode, and water is electrolyzed to generate hydrogen ions (H⁺). On the other hand, in the cathode region, no metal ions are dissolved out, but water is electrolyzed to generate hydrogen gas (H₂) and hydroxyl ions (OH⁻) as shown in equation (5) above.

When wastewater is passed through the electrocoagulation tank including the electrode assembly comprising the positive and cathodes in the process of removing suspended solids from water using the characteristics of electrocoagulation, the metal ion dissolved from the anode and the hydroxyl radical produced in the cathode region will react with each other to form a metal hydroxide, and the suspended solids to be removed will be removed by adsorption on the metal hydroxide.

On the other hand, when wastewater is treated in the electrocoagulation tank including the electrode assembly having the positive and cathodes in the same manner as the suspended-solid removal method in order to remove phosphate ions from water, metal ions such as dissolved iron or aluminum ions will react not only with phosphate ions, but also with hydroxyl radicals, and the efficiency of removal of phosphorus will decrease due to the competitive reaction. In addition, as described above, metal hydroxide is produced as a byproduct, thus significantly increasing the cost for treating solids.

The present invention fundamentally solves such problems occurring in the electrocoagulation method. Specifically, according to the present invention, a porous membrane is placed between an anode and a cathode to separate the anode from the cathode. When the porous membrane is placed between the two electrodes, metal ions are dissolved from the anode and water is electrolyzed in the anode region, thereby dissociating hydrogen ions. Herein, the pH of the anode region changes to an acidic pH lower than 7 or 5-6, at which the chemical reaction between the metal ions and the phosphate ions is facilitated.

Meanwhile, in the cathode region, water is electrolyzed and hydrogen ions are converted into hydrogen gas which forms bubbles. Herein, the pH of the cathode region is maintained at an alkaline pH greater than 7. In conclusion, when the anode reaction is separated from the cathode reaction by the porous membrane, phosphorus is removed under acidic conditions in which metal ions can easily bind to phosphate ions in the anode reaction. In the cathode reaction, metal ions do not form a metal hydroxide which generates a scum.

The treated water passed through the electrocoagulation tank is introduced into a mixing tank. In the mixing tank, a phosphate precipitate bound to the metal ions dissolved from the anode is mixed with phosphate ions which were not treated in the cathode region, and the mixture is removed by reaction with metal ions remaining after the reaction in the anode region.

Herein, a stirrer 310 is provided in the mixing tank such that the size of particles can be increased by colliding the particles with each other using the stirring power of the stirrer, thereby facilitating the precipitation of the particles.

If metal ions are dissolved from the anode of the electrode assembly in an amount larger than an appropriate amount, they cause a problem in term of the color of treated water. For this reason, a solution of a metal ion-reducing agent (e.g., sodium borohydride (NaBH₂)) is allowed to react with the metal ions at a molar ratio of about 1:1.5.

Through this reaction, the hydrogen ion (4H⁺) of sodium borohydride reduces a metal ion (Fe⁺², Fe⁺³ or Al⁺³) into a zero-valent metal (Fe° or Al°), thereby removing color from the treated water. In addition, the reduced metal has increased specific gravity and is mixed with the metal phosphate to facilitate the settlement of the sludge.

The inventive method of removing phosphorus from sewage wastewater by electrocoagulation using electrodes having a porous membrane therebetween can be summarized as follows. In order to efficiently remove phosphorus from sewage wastewater containing soluble phosphorus in the electrocoagulation tank and to minimize the regeneration of sludge caused by metal hydroxide, the porous membrane is placed between the anode and the cathode, and the removal of phosphorus is performed on only the anode from which metal ions are dissolved. In addition, phosphorus which was not treated in the cathode region is treated by stirring in the mixing tank, and the released metal ions are reduced into the original zero-valent metal using sodium borohydride, and the reduced metal is mixed with metal phosphate, thereby enhancing the settlement of sludge.

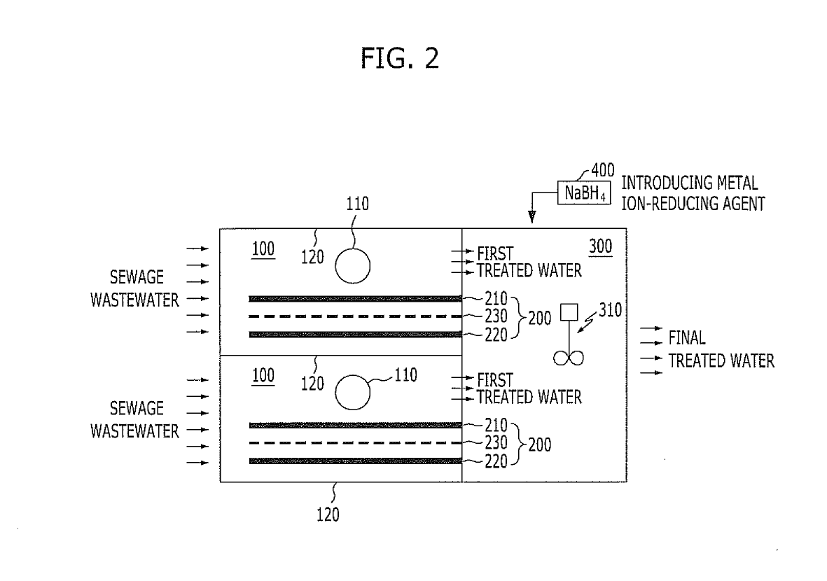

Hereinafter, a preferred embodiment of an apparatus of removing phosphorus from sewage wastewater using an electrocoagulation apparatus having a porous membrane, which is used to carry out the above-described method of removing phosphorus by electrocoagulation, will be described in detail with reference to FIG. 2.

FIG. 2 schematically shows one preferred embodiment of the inventive apparatus of removing phosphorus from sewage wastewater by electrocoagulation using electrodes having a porous membrane therebetween.

As shown in FIG. 2, the inventive apparatus of removing phosphorus from sewage wastewater by electrocoagulation using electrodes having a porous membrane therebetween comprises: an electrode assembly 200 comprising a porous membrane 230 between an anode 210 and a cathode 220; at least one electrocoagulation chamber 100 in which the electrode assembly 100 is placed and sewage wastewater is first treated by electrocoagulation using the electrode assembly; and a mixing chamber 300 which is placed at one side of the electrocoagulation chamber (downstream side in the direction in which sewage is treated) and in which treated water passed through the anode 210 is mixed with treated water passed through the cathode 220 and the mixed water is further treated in order to remove phosphorus which was not treated in the region of the cathode 220.

At one side of the lower portion of the electrocoagulation chamber 100, an air injection device (air stone) 110 is placed in order to uniformly mix the phosphate ions of sewage with the metal ions dissolved from the electrodes. Herein, the air stone 110 is preferably placed below the anode 110.

In addition, the apparatus of the present invention further comprises a device for introducing a metal ion-reducing agent 400 into the mixing tank 300 in order to remove color from the treated water provided from the electrocoagulation tank 100 and to enhance the settlement of sludge generated by electrocoagulation.

As the metal ion-reducing agent 400, sodium borohydride is injected. Thus, the dissolved metal ions are reduced into the original zero-valent metal by the injected sodium borohydride, and the reduced metal is mixed with metal phosphate, thereby enhancing the settlement of sludge generated by electrocoagulation.

In the present invention, the electrocoagulation tank 100 preferably is divided into a plurality of regions by a water-impermeable partition 120. Herein, the water-impermeable partition 120 is located closer to the cathode 220 of the electrode assembly 200 than the anode 210. It can be seen that, even in the case in which one electrocoagulation tank 100 is provided, the water-impermeable partition is located closer to the cathode 220 of the electrode assembly than the anode. In other words, the electrode assembly 200 is placed in the electrocoagulation tank such that a reaction region (space) in which the anode is located is larger than a reaction region (space) in which the cathode is located.

The porous membrane 230 of the electrode assembly 200 is made of nonwoven fabric.

For example, the distances between the anode 210, the cathode 220 and the porous membrane 230 are as follows. In the electrocoagulation tank 100, the distance between the anode 210 and the porous membrane 230 is about 2.5 cm, and the distance between the porous membrane 230 and the cathode 220 is about 2.5 cm, suggesting that the distance between the two electrodes is about 5 cm. In this case, the dissolution of metal ions from the anode 210 is rapid, and migration of charges between the two electrodes 210 and 220 through the porous membrane 230 becomes smooth.

Furthermore, the distance between the water-impermeable partition 120 and the anode 210 is about 30 cm, and the distance between the water-impermeable partition 120 and the cathode 220 is about 10 cm, so that phosphorus contained in sewage is mostly removed in the region of the anode 210. In addition, an air injection device 110 is located at the bottom of the anode region in order to uniformly mix metal ions with phosphate ions.

Hereinafter, the results of a test carried out by the present inventor for phosphorus removal by the prior method and phosphorus removal by the inventive method will be described.

The test was carried out for two cases: one case (prior electrocoagulation method) in which the distance between the anode and the cathode was maintained at 4 cm; and another case (method of the present invention) in which the distance between the anode and the cathode was maintained at 5 cm and a porous nonwoven fabric barrier was placed therebetween. Under these conditions, removal of soluble phosphorus from water was carried out, and the results were compared between the two cases.

As the material to be treated, sewage was used. In order to verify whether an increase in the efficiency of removal of phosphorus and a decrease in the amount of metal hydroxide generated during the removal of phosphorus, which are the objects of the present invention, are achieved, influent sewage was filtered to reduce the concentration of suspended solids to about 2 mg/L. In addition, KH₂PO₄ was added to increase the concentration of phosphate and maintain the concentration of soluble phosphorus at about 10 mg/L. The pH of influent sewage was maintained at 7.2 (corresponding to the pH of raw water).

An iron electrode was used in this test, even though an aluminum electrode could also be used. DC current was supplied and the current per unit electrode area was maintained constant at about 12 V. The size of unit electrode was 10 cm (L)×10 cm (H)×8 cm (W). Also, the porous nonwoven fabric barrier had the same size. The hydraulic reaction time was about 10 minutes in the electrocoagulation tank and about 15 minutes in the mixing tank, and the precipitation time was about 30 minutes.

Table 1 below shows changes in pH, soluble phosphorus removal, metal phosphate and metal hydroxide sludge concentration (expressed as SS) and iron concentration in the case in which the anode and the cathode were placed without having the porous membrane therebetween. Table 2 below show changes in pH, soluble phosphorus removal, metal phosphate and metal hydroxide sludge concentration (expressed as SS) and iron concentration in the case in which the porous membrane was placed between the anode and the cathode.

TABLE 1

| | Anode/cathode | | | |
|---|---|---|---|---|
| Process | pH | SS (mg/L) | PO₄⁻³ (mg/L) | Iron (mg/L) |
| Electrocoagulation tank | 7.8 | — | 4.5 | 12 |
| Mixing tank | 7.8 | 18.5 | 3.8 | 10 |
| Settled water | 7.8 | 2.5 | 3.5 | 8 |
| (supernatant in mixing | | | | |
| tank) | | | | |

* supernatant: clear liquid present above precipitate

TABLE 2

| | Anode/porous membrane/cathode | | | | | | | |
|---|---|---|---|---|---|---|---|---|
| | pH | | SS | | PO₄⁻³(mg/L) | | Iron(mg/L) | |
| Process | Positive | Negative | Positive | Negative | Positive | Negative | Positive | Negative |
| Electrocoagulation | 7.2→6.1 | 7.2→10.8 | 62 | 0 | 0.3 | 7.5 | 12 | 0.3 |
| tank | | | | | | | | |

| | | | | |
|---|---|---|---|---|
| Mixing tank | 7.3 | 73 | 1.2 | 10 |
| Settled water | 7.3 | 2 | 0.1 | 0.1 |
| (supernatant in | | | | |
| mixing tank) | | | | |

As can be seen in Table above, in the case in which the anode and the cathode were placed without having the porous membrane therebetween, the pH changed to a weakly alkaline pH, and the concentration of suspended solids (SS) caused by metal phosphate and metal hydroxide increased up to 185 mg/L in the mixing tank. Even after the settlement process was performed, the amount of suspended solids remaining in the supernatant was significantly large due to an increase in buoyancy caused by hydrogen gas generated in the cathode region. In addition, the efficiency of removal of phosphate was low, and iron remained in the settled water which was reddish.

On the other hand, the porous nonwoven fabric membrane was placed between the positive and cathodes, the pH of the anode region changed to an acidic pH which was very advantageous for removal of phosphorus, and the efficiency of removal of phosphorus was very high. Moreover, no metal hydroxide was formed, and thus the concentration of suspended solids (SS) was very low. In addition, because sodium borohydride was injected, iron ions did not remain after the settlement process, and thus colorless clean treated water could be obtained.

Thus, it can be seen that, when the porous membrane is used between the anode and the cathode in the process of removing phosphorus by electrocoagulation, the efficiency of removal of phosphorus can be increased and the generation of suspended solids can be reduced. In addition, it can be seen that, when the metal ion-reducing agent is injected, not only the efficiency of removal of color, but also the efficiency of settlement were significantly excellent.

In the inventive method and apparatus of removing phosphorus from sewage by electrocoagulation using electrodes having a porous membrane therebetween, phosphorus can be removed from sewage, while the production of a sludge of metal hydroxides such as iron oxide or aluminum hydroxide can be inhibited, thus reducing the amount of precipitates. Furthermore, a scum can be prevented from being generated by hydrogen gas. In addition, the final treated water has no color, and the settlement of sludge generated by electrocoagulation can be enhanced.

As described above, the inventive method and apparatus of removing phosphorus from sewage by electrocoagulation using electrodes having a porous membrane therebetween have the following effects.

First, according to the present invention, phosphorus can be removed from sewage, while the production of a sludge of metal hydroxides such as iron hydroxide or aluminum hydroxide can be inhibited, thus reducing the amount of precipitates.

Second, a scum can be prevented from being generated by hydrogen gas.

Third, the final treated water has no color, and the settlement of sludge generated by electrocoagulation can be enhanced.

Although the preferred embodiments of the present invention have been described for illustrative purposes, those skilled in the art will appreciate that various modifications, additions and substitutions are possible, without departing from the scope and spirit of the invention as disclosed in the accompanying claims.

1. A method of removing phosphorus from sewage wastewater by electrocoagulation, the method comprising:
providing an electrocoagulation tank for treating sewage, the electrocoagulation tank including an electrode assembly comprising an anode and a cathode with a porous membrane interposed therebetween;
passing sewage wastewater through the electrocoagulation tank to treat the sewage wastewater by electrocoagulation; and
introducing the treated water, passed through the electrocoagulation tank, into a mixing tank.

2. The method of claim 1, wherein the method further comprises:
injecting air from a bottom of a space, which includes the anode, when treating the sewage wastewater by electrocoagulation; and
stirring the treated water introduced into the mixing tank.

3. The method of claim 1, wherein the method further comprises introducing a metal ion-reducing agent into the mixing tank in order to remove color from the treated water and enhance settlement of sludge generated by the electrocoagulation.

4. A method of removing phosphorus from sewage wastewater by electrocoagulation, the method comprising:
providing an electrode assembly comprising an anode and a cathode with a porous membrane interposed therebetween;
placing the electrode assembly in an electrocoagulation tank for treating sewage wastewater;
passing sewage wastewater through the electrocoagulation tank to treat the sewage wastewater by electrocoagulation; and
introducing the treated water, passed through the electrocoagulation tank, into a mixing tank to further treat the treated water.

5. The method of claim 4, wherein placing the electrode assembly in the electrocoagulation tank is performed such that a space including the anode is larger than a space including the cathode.

6. The method of claim 5, wherein the method further comprises injecting air from a bottom of a space, which includes the anode, into the electrocoagulation tank, in order to uniformly mix metal ions, generated by electrocoagulation, with phosphate ions contained in the sewage wastewater.

7. The method of claim 5, wherein the method further comprises stirring the treated water introduced into the mixing tank, when further treating the treated water.

8. The method of claim 5, wherein the method further comprises introducing a metal ion-reducing agent into the mixing tank in order to remove color from the treated water and enhance the settlement of sludge generated by the electrocoagulation.

9. The method of claim 8, wherein the electrodes are iron or aluminum electrodes, and the metal ion-reducing agent is sodium borohydride (NaBH₄).

10. An apparatus of removing phosphorus from sewage wastewater by electrocoagulation, the apparatus comprising:
an electrode assembly comprising an anode and a cathode with a porous membrane interposed therebetween;
at least one electrocoagulation tank in which the electrode assembly is placed and sewage wastewater is treated by electrocoagulation using the electrode assembly; and
a mixing tank, which receives the treated water from the electrocoagulation tank and in which the treated water passed through the anode and the treated water passed through the anode are mixed with each other and further treated so as to remove phosphorus which was not treated in the electrocoagulation tank.

11. The apparatus of claim 10, wherein the electrode assembly is placed in the electrocoagulation tank such that a space including the anode of the electrode assembly is larger than a space including the cathode.

12. The apparatus of claim 11, wherein the apparatus further comprises an air injection device, which serves to inject air into the electrocoagulation tank in order to uniformly mix phosphate ions of the sewage wastewater with metal ions dissolved from the electrodes, the air injection device being placed at a bottom of the space including the anode.

13. The apparatus of claim 10, wherein the apparatus further comprises a device which serves to introduce a metal ion-reducing agent into the mixing tank in order to remove color from the treated water and enhance the settlement of sludge generated by the electrocoagulation.

14. The apparatus of claim 13, wherein the anode and cathode of the electrode assembly are made of iron or aluminum, the porous membrane of the electrode assembly is made of nonwoven fabric, and the metal ion-reducing agent is sodium borohydride (NaBH₄).

15. The apparatus of claim 14, wherein a distance between the porous membrane and the anode and a distance between the porous membrane and the cathode are such that migration of charges therebetween is possible, and a distance between the cathode and a partition wall of the electrocoagulation tank is shorter than a distance between the cathode and the partition wall of the electrocoagulation tank.
